(19) United States
(12) Patent Application Publication
(10) Pub. No.: US 2006/0097844 A1
(43) Pub. Date: May 11, 2006

(54) Entry control system and method using biometrics

(75) Inventors: Kazuhiro Nakashima, Kariya-city (JP); Kentaro Teshima, Kariya-city (JP); Ifushi Shimonomoto, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/268,774

(22) Filed: Nov. 8, 2005

(30) Foreign Application Priority Data
Nov. 10, 2004 (JP) 2004-326819

(51) Int. Cl. G05B 19/00

(52) U.S. Cl. 340/5.52; 382/115; 340/5.61; 340/5.72; 307/10.5

(57) ABSTRACT

An entry control system for a vehicle has a transmitter for transmitting a transmission request signal, a receiver for receiving a response signal including an ID code from a portable device, and a biometrics sensor for detecting a face image of a user. The system compares the face image provided by the biometrics sensor with registered face image. If these images agree, the system then activates the transmitter and compares the ID code received from the portable device with a registered ID code. If these codes also agree, the system allows the user to open a door and start an engine of the vehicle.

### CROSS REFERENCE TO RELATED APPLICATION

This application is based on and incorporates herein by reference Japanese patent applications No. 2004-326819 filed on Nov. 10, 2004, and No. 2005-320910 filed on Nov. 4, 2005.

### FIELD OF THE INVENTION

The present invention relates to an entry control system and method for a vehicle, a building or the like.

### BACKGROUND ART

In a conventional entry control system such as a smart entry system disclosed in JP 2000-104429A or JP 2003-157483A (U.S. Pat. No. 6,879,247), a control device mounted in a vehicle transmits a transmission request signal in a predetermined area of radio communication around a vehicle, and an electronic key carried as a portable device by a user entering in the predetermined area transmits a response signal including an ID code in response to the request signal. The control device compares the ID code included in the response signal with a stored ID code. The control device then performs a predetermined standby control to allow door unlocking, engine starting or the like, if the two ID codes agree, that is, if the portable device is determined to be an authorized one. This system allows even an unauthorized user to unlock a vehicle door and start an engine as long as the portable device is the authorized one. Therefore, higher security is needed to prevent such an unauthorized user from using the vehicle.

### SUMMARY OF THE INVENTION

It is therefore an object of the present invention to improve security level of an entry control system and method.

An entry control system has a transmitter for transmitting a transmission request signal, a receiver for receiving a response signal including identification information such as an ID code from a portable device, and a biometrics sensor for detecting biometrics information such as a face image of a user. The system compares the detected biometric information with registered biometric information. The system further compares the received identification information with registered identification information. The system allows the user to enter only when both the detected biometric information and the received identification information agree with the respective registered information.

### BRIEF DESCRIPTION OF THE DRAWINGS

The above and other objects, features and advantages will become more apparent from the following detailed description made with reference to the accompanying drawings. In the drawings:

FIG. 1 is a block diagram showing an entry control system;

FIG. 2 is a flow diagram showing control processing performed in a first embodiment;

FIG. 3 is a flow diagram showing control processing performed in a second embodiment;

FIG. 4 is a flow diagram showing control processing performed in a third embodiment;

FIG. 5 is a flow diagram showing a part of control processing performed in a fourth embodiment;

FIG. 6 is a flow diagram showing the other part of control processing performed in the fourth embodiment; and

FIG. 7 is a flow diagram showing control processing performed in a fifth embodiment.

### DETAILED DESCRIPTION OF EMBODIMENTS

### First Embodiment

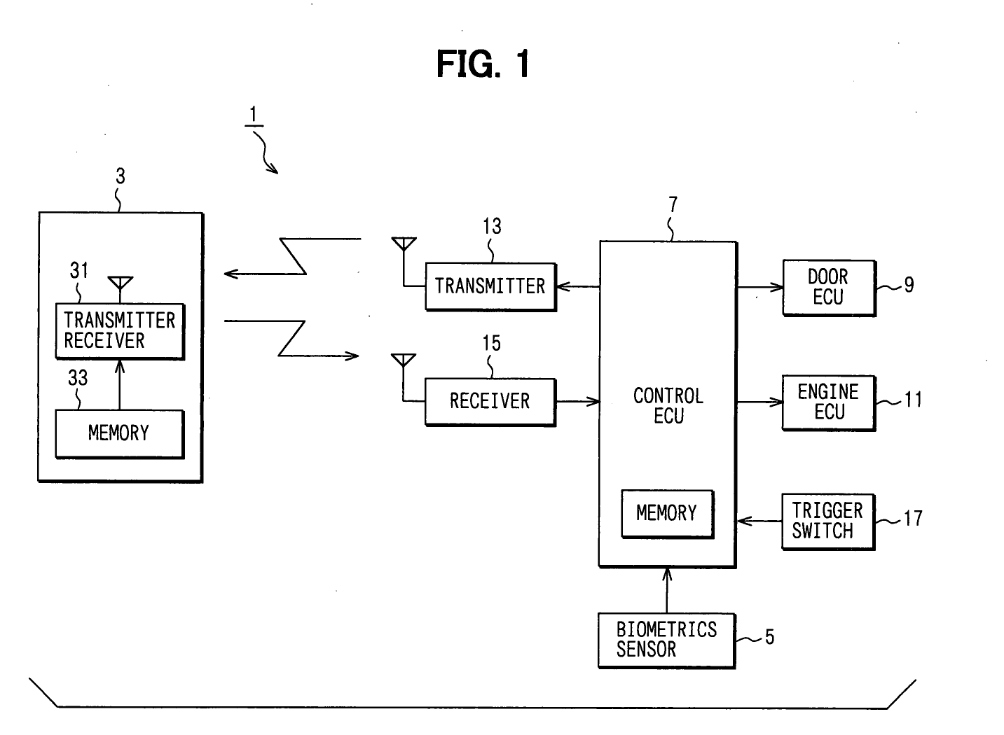

Referring first to FIG. 1, an entry control system 1 is provided as a smart entry system for a vehicle (not shown). The system 1 includes a portable device 3 in the form of an electronic key carried by a user of a vehicle, and a control device mounted in the vehicle. The control device includes a biometrics sensor 5, an electronic control unit (control ECU) 7, a door ECU 9, an engine ECU 11, a radio transmitter 13, a radio receiver 15 and a trigger switch 17.

The biometrics sensor 5 detects biometric information of a user. The control ECU 7 checks identification information (ID code) received from the portable device 3 via radio communication through the antennas of the transmitter 13 and the receiver 15, and checks the biometric information received from the biometrics sensor 5. If these information are validated, the control ECU 7 outputs commands to the door ECU 9 and the engine ECU 11.

When the door ECU 9 receives an unlocking permission command allowing unlocking of a door from the control ECU 7, it becomes a standby condition for the door unlocking. When the user touches a touch sensor provided on the inner side of an outside door handle (door knob) under this standby condition, the door ECU 9 automatically unlocks each door to allow the user to open the door.

When the engine ECU 11 receives an engine starting permission command allowing starting of an engine from the control ECU 7, it becomes a standby condition for the engine starting. When the user pushes a start switch provided near a steering wheel under this standby condition, the engine ECU 11 starts to crank the engine by a starter.

In this system 1, the trigger switch 17 may be provided on the outer side of the door handle of the door next to the driver's seat and operable to trigger biometric identification processing in which the detected biometric information is checked by the control ECU 7.

The control ECU 7 is programmed to perform face identification as the biometric identification. The biometrics sensor 5 therefore uses a camera to photograph a face of a user trying to open the door next to the driver's seat and outputs electronic image data of the photographed face to the control ECU 7 as the biometric information.

The transmitter 13 is provided in each door to transmit a transmission request signal in a predetermined area of radio communication around the vehicle when activated by the control ECU 7. The request signal may be in the frequency band of about one hundred several tens KHz. The receiver 15 is provided in a rear view mirror in the passenger compartment to receive a response signal from the portable device 3 generated in response to the request signal. The response signal may be in the frequency band of about several hundreds MHz and includes an ID code as identification information specific to each portable device or vehicle. The receiver 15 decodes the ID code included in the response signal and applies it to the control ECU 7.

The portable device 3 includes a transmitter/receiver 31 and a memory 33. The transmitter/receiver 31 receives the request signal of the transmitter 13 and transmits in return the response signal. The memory 33 stores therein the ID code specific to the portable device 3. This ID code varies from one portable device to another.

The control ECU 7 is a microcomputer including a CPU, ROM, RAM and the like. This ROM is a memory that stores therein an ID code as a registered ID code specifically assigned to the portable device of each vehicle, that is, the vehicle mounting the control ECU 7. This ROM also stores therein image data of a face of each user authorized to use the vehicle. This image data is registered biometric information of the authorized user.

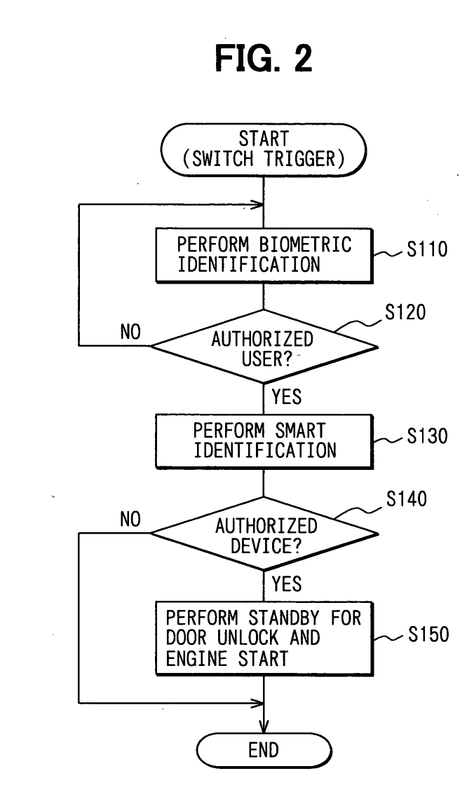

The control ECU 7 starts entry processing shown in FIG. 2, when a predetermined validation or identification condition is satisfied. This condition may include that the vehicle is parked, all the doors are locked, and the trigger switch 17 is operated.

As shown in FIG. 2, the ECU 7 performs biometric identification at step (S) 110. In this processing, the ECU 7 activates the biometrics sensor 5 to photograph the face of a person present near the door. When the face image data is transmitted form the biometrics sensor 5, the ECU 7 compares this biometric information with the registered biometric information at S120. If both biometric information do not agree (unsuccessful identification), that is, the person near the door is not an authorized user, S110 and S120 are repeated.

If both biometric information agree (successful identification), the ECU 7 then performs a smart identification at S130. In this processing, the ECU 7 activates the transmitter 13 to transmit a response request signal. When a response signal is transmitted from the portable device 3 and received by the receiver 15 within a predetermined period, the ECU 7 compares an ID code included in the received response signal with the registered ID code at S140. If both codes do not agree, that is, the portable device 3 is not an authorized one, no more processing is attained. No more processing is performed either when the receiver 15 receives no response signal from the portable device 3.

If both ID codes agree, the ECU 140 performs a predetermined standby operation at S150 by issuing the door unlocking permission command to the door ECU 9 and the engine starting permission command to the engine ECU 11. Thus, the user is allowed to open the door and start the engine by only touching the touch sensor of the door handle and pressing the engine start switch.

According to this embodiment, the biometric identification is performed in addition to the smart identification. Therefore, an unauthorized user is not allowed to use the vehicle even if he/she carries an authorized portable device, thus improving security level of the system. Further, the transmitter 13 is activated to transmit the request signal at S130 only after the biometric identification is performed at S110, and the request signal may be transmitted within a very limited area, that is, only near the driver's seat. As a result, electric power consumed by the transmitter 13 is reduced.

### Second Embodiment

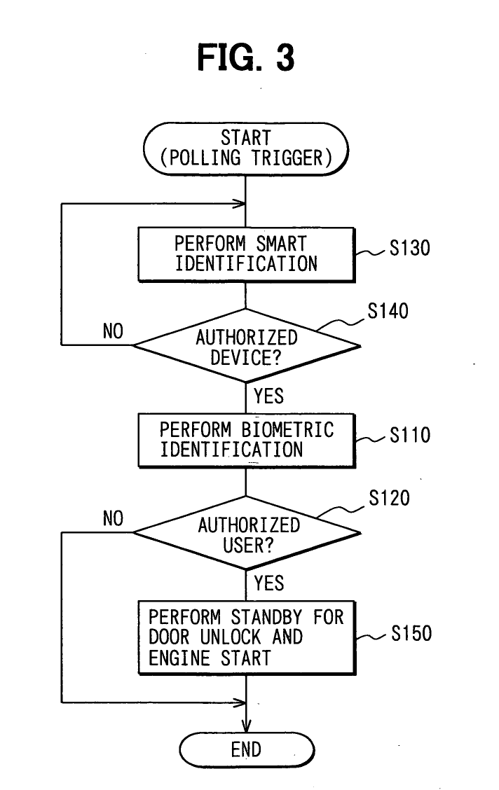

The second embodiment is different from the first embodiment (FIG. 2) in that, as shown in FIG. 3, the ECU 7 first performs the smart identification (S130 and S140) and then the biometric identification (S110 and S120).

It is noted in this embodiment that the ECU 7 activates the transmitter 13 at S130 to transmit the response request signal in the predetermined area wider than the limited area near the driver's seat in the first embodiment and the receiver 15 waits for the response signal (polling processing). The ECU 7 activates the biometrics sensor 5 at S110 and performs comparison of face image data when the face image data is received from the biometrics sensor 5 within a predetermined period after activation.

The second embodiment may be modified so that the transmitter 13 is activated to transmit the request signal each time the trigger switch 17 is operated in place of the polling processing. Further the biometrics sensor 5 may be activated to photograph the face of a user when the trigger switch 17 is operated.

### Third Embodiment

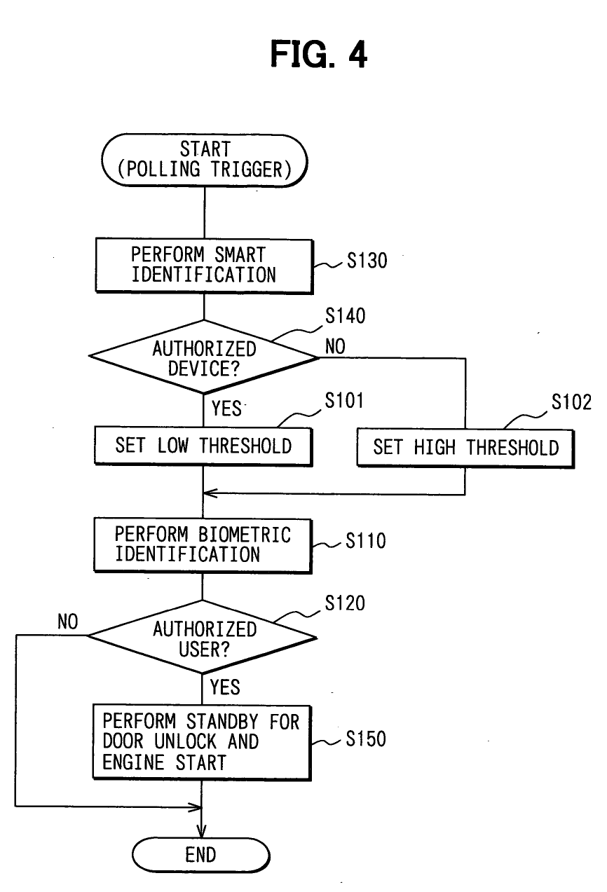

The third embodiment is different from the second embodiment (FIG. 3) in that, as shown in FIG. 4, the ECU 7 performs S101 and S102 between the smart identification (S130 and S140) and the biometric identification (S110 and S120). S101 and S102 are for selecting one of different threshold levels which are used in determining whether the user is an authorized user or not by comparing the face image data with the registered face image data. Specifically, S 01 selects a low threshold level so that the photographed face is determined to be similar to the authorized user with higher probability. On the other hand, S102 selects a high threshold level so that the photographed face is determined to be similar to the authorized user with low probability.

The ECU 7 performs the biometric identification at S110 by using the low threshold level selected at S101, when the portable device 3 is determined to be the authorized one at S140. The ECU 7 performs, on the other hand, the biometric identification at S110 by using the high threshold level selected at S101, when the receiver 15 receives no response signal from the portable device or when the portable device 3 is determined to be not the authorized one at S140.

According to this embodiment, the biometric identification is performed at S110 and S120, even if the portable device 3 does not transmit the response signal or the portable device 3 is not determined to be the authorized one (NO at S140). However, the biometric identification at S110 is performed by using the higher threshold level.

Therefore, even if the portable device 3 is not determined to be the authorized one for some reason, the user will be more likely to be determined to be not the authorized one because similarity is determined with higher threshold level. Further, once the portable device 3 is determined to be the authorized one, the user is more likely to be determined to be the authorized user owing to the low threshold level even if the user is photographed in a poor photographing condition or has hair style or the like different from the registered one. Thus, this embodiment will enhance usability of the entry control system while still keeping a high security level.

In the third embodiment, as in the second embodiment, the transmitter 13 may be activated each time the trigger switch 17 is operated, or the biometrics sensor 5 may be activated each time the trigger switch 17 is activated.

### Fourth Embodiment

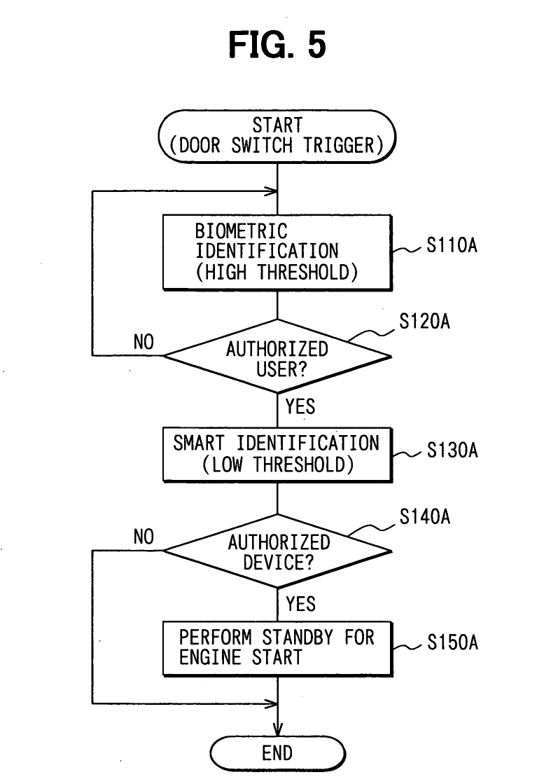

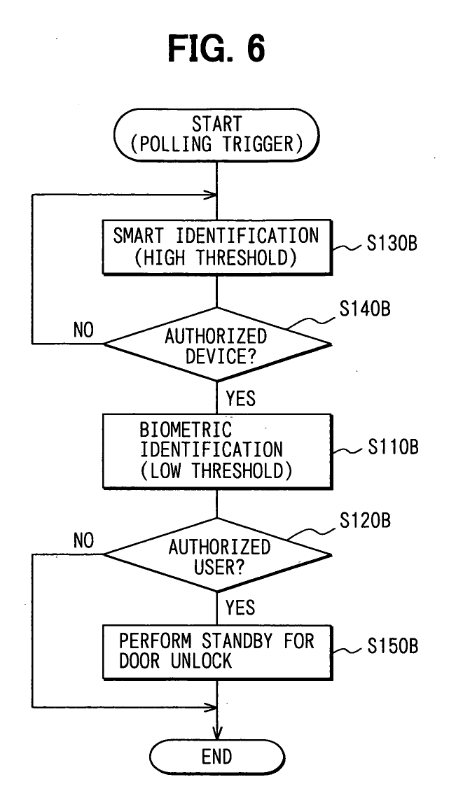

The fourth embodiment is a combination of the first embodiment (FIG. 2) and the second embodiment (FIG. 3). It is however different in the following points. That is, as shown in FIGS. 5 and 6, the ECU 7 performs the biometric identifications by using a high threshold level at S110A and S120A (FIG. 5) and a low threshold at S110B and S120B (FIG. 6). The ECU 7 performs the smart identifications by using a low threshold level at S130A and 140A (FIG. 5) and a high threshold at S130B and S140B (FIG. 6). Further, the ECU 7 performs the standby processing for the engine starting at S150A (FIG. 5) and the standby processing for the door unlocking at S150B (FIG. 6).

### Fifth Embodiment

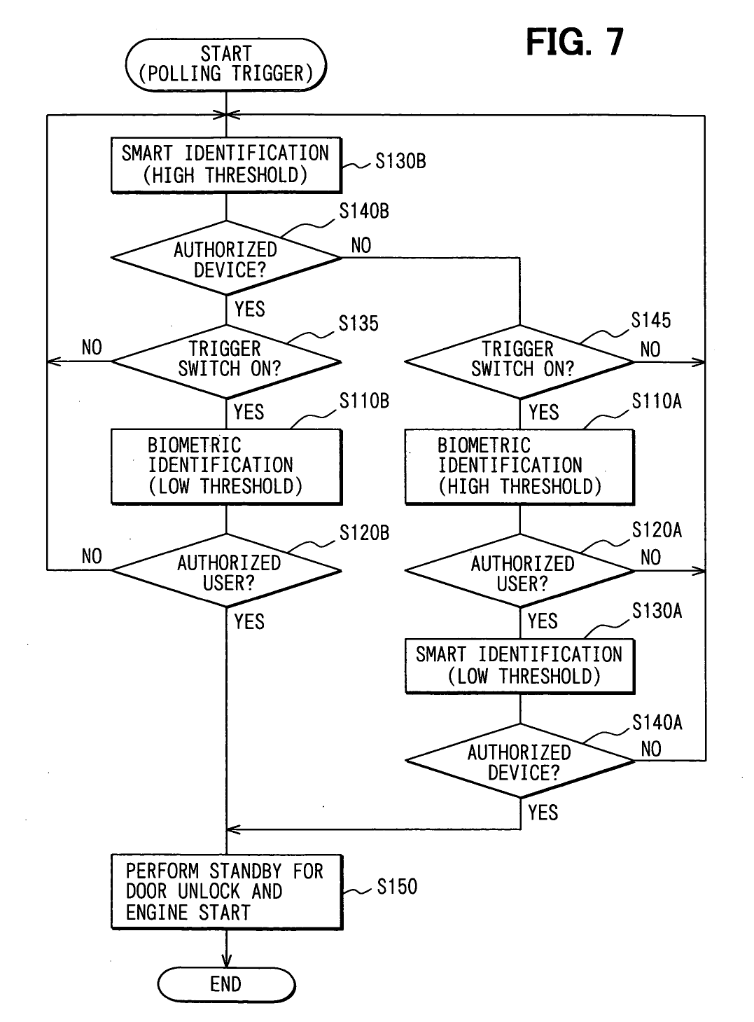

The fifth embodiment is different from the third embodiment (FIG. 4) in that, as shown in FIG. 7, the ECU 7 performs the smart identification by using a high threshold level at S130B and S140B. If the portable device 3 is determined to be the authorized one (YES at S140B), the ECU 7 checks at S135 whether the trigger switch 17 on the door is operated. If the portable device 3 is determined to be not the authorized one (NO at S140B), the ECU checks at S145 whether the trigger switch 17 on the door is operated. If the trigger switch is operated (YES at S135 and S145), the ECU 7 performs the biometric identifications by using a low threshold level and a high threshold level at S110B, S120B and S110A, S120A, respectively.

If the user is determined to be not the authorized user at S120B and S120A, the ECU 7 repeats this routine again and hence the door unlocking and engine starting are not allowed. If the user is determined to be the authorized user at S120B, the ECU 7 performs the standby operation at S150 to allow the door unlocking and the engine starting.

If the user is determined to be not the authorized user at S120A, the ECU 7 performs the smart identification (S130B and S140B) again. If the user is determined to be the authorized user at S120A, on the other hand, the ECU 7 performs the smart identification again by using a low threshold level at S130A. If the portable device 3 is determined to be the authorized one at S140A, the ECU 7 allows the door unlocking and the engine starting at S150. If the portable device 3 is determined to be not the authorized one at S140A, the ECU 7 repeats the above steps.

When two threshold levels are used for each of the smart identification and the biometric identification, security level can be improved while maintaining responsiveness of the identification process.

In the above embodiments, the high threshold level and the low threshold level may be differentiated by the number of bits of ID codes used in the smart identification and by the number of image data used in the biometric identification. For instance, in the case of low threshold level, the numbers of ID codes and the frames of image data may be reduced to one half of the numbers in the case of high threshold level.

Further, the biometric information may be other information of a user such as a finger print, an iris, a voice pattern or a vein pattern.

The above embodiments may be used for other security systems such as homes and buildings.

What is claimed is:

1. An entry control system comprising:
a transmitter for transmitting a transmission request signal in a predetermined area;
a receiver for receiving a response signal transmitted from a portable device in response to the transmission request signal, the response signal including identification information specific to the portable device;
a smart identification means for performing a smart identification to determine whether received identification information agrees with registered identification information;
a biometrics detection means for detecting biometric information;
a biometric identification means for performing a biometric identification to determine whether detected biometric information agrees with registered biometric information; and
a control means for causing one of two identification means to perform an identification thereof in a predetermined identification condition, for causing the other of two identification means to perform an identification thereof when an identification by the one of the two identification means is successful, and for allowing an entry of a user when the other of two identification means is successful.

2. The entry control system according to claim 1, wherein:
the one of two identification means is the biometric identification means; and
the other of two identification means is the smart identification means.

3. The entry control system according to claim 1, wherein:
the one of two identification means is the smart identification means; and
the other of two identification means is the biometric identification means.

4. The entry control system according to claim 3, wherein:
the biometric identification means performs the biometric identification even when the smart identification is unsuccessful; and
the biometric identification means uses a low threshold level and a high threshold level in performing the biometric identification, when the smart identification is successful and unsuccessful, respectively.

5. The entry control system according to claim 4, wherein:
the biometric information detection means photographs a face of the user as the biometric information; and
the biometric identification means compares a photographed face with a registered face.

6. The entry control system according to claim 2, wherein:
the smart identification means uses only a part of the received identification information and a part of the registered identification information in the smart identification, when the biometric identification is successful.

7. The entry control system according to claim 3, wherein:
the biometric identification means uses only a part of the detected biometric information and a part of the registered biometric information in the biometric identification, when the smart identification is successful.

8. The entry control system according to claim 6, wherein:
the biometric identification means uses a whole of the detected biometric information and a whole of the registered biometric information in the biometric identification.

9. The entry control system according to claim 4, wherein:
the smart identification means uses a whole of the received identification information and a whole of the registered identification information in the smart identification.

10. The entry control system according to claim 4, wherein:
the smart identification means performs the smart identification again by using a lower threshold level than a first time smart identification, when the biometric identification by using the high threshold level is successful.

11. An entry control system comprising:
a transmitter for transmitting a transmission request signal in a predetermined area;
a receiver for receiving a response signal transmitted from a portable device in response to the transmission request signal, the response signal including identification information specific to the portable device;
a smart identification means for performing a smart identification to determine whether received identification information agrees with registered identification information;
a trigger switch provided on a door;
a biometrics detection means for detecting biometric information;
a biometric identification means for performing a biometric identification to determine whether detected biometric information agrees with registered biometric information; and
a control means for controlling an operation of the smart identification means and the biometric identification means,
wherein the control means causes, when the receiver receives the response signal, the smart identification means to perform the smart identification with a first high threshold level, subsequently causes the biometric identification with a second low threshold level, and allows an entry through the door if both of the identification means output positive identification results, and
wherein the control means causes, when the trigger switch is operated, the biometrics identification means to perform the biometric identification with a second high threshold level higher than the second low threshold level, subsequently causes the smart identification means to perform the smart identification with a first low threshold level lower than the first high threshold level, and allows an engine starting if both of the identification means output positive identification results.

12. An entry control method for a vehicle having a transmitter for transmitting a transmission request signal in a predetermined area, a receiver for receiving a response signal transmitted from a portable device in response to the transmission request signal, the response signal including identification information specific to the portable device, and a biometrics sensor for detecting biometric information, the method comprising:
performing a first identification to determine whether received identification information agrees with registered identification information;
performing a second identification to determine whether detected biometric information agrees with registered biometric information; and
allowing an entry of a user only when both identifications are successful.

13. The entry control method according to claim 12, wherein:
the first identification is performed first followed by the second identification; and
the second identification uses a high threshold and a low threshold when the first identification is unsuccessful and successful, respectively.

14. The entry control method according to claim 12, wherein:
the second identification is performed first followed by the first identification; and
the first identification uses a high threshold and a low threshold when the second identification is unsuccessful and successful, respectively.
